(19) United States
(12) Patent Application Publication
(10) Pub. No.: US 2015/0154653 A1
(43) Pub. Date: Jun. 4, 2015

(54) ADVERTISING BUSINESS MODEL AND CONTENT CREATION SYSTEM FOR COMMUNITIES OF LIKE-MINDED PEOPLE

(71) Applicant: Yevhenii Moroz, San Francisco, CA (US)

(72) Inventor: Yevhenii Moroz, San Francisco, CA (US)

(21) Appl. No.: 14/557,747

(22) Filed: Dec. 2, 2014

Related U.S. Application Data
(60) Provisional application No. 61/910,938, filed on Dec. 2, 2013.

(51) Int. Cl. G06Q 30/02; G06Q 50/00

(52) U.S. Cl. CPC G06Q 30/0274; G06Q 50/01

(57) ABSTRACT

System and method for online marketing and advertising. The owner/manager of a place runs advertising campaigns and thus remunerates a writer of a story based on the popularity of the story among visitors to the place who vote for the story. Content curators who create and/or manage the content in a place can also be given financial incentives or rewards. A mechanism for investing internal or external attracted capital in content creation and user acquisition, the mechanism providing a return on investment. A mechanism for searching highlights, stories, places, peers, and other information, wherein the search can be enhanced based on a likeness index. Publish stories in guides, curate, promote, and otherwise manage the crowd-sourced content, which can be owned by the authors.

### CROSS-REFERENCE

This disclosure claims priority from U.S. Provisional Patent Application No. 61/910,938 entitled Advertising Business Model and Content Creation System for Communities of Like-Minded People, filed Dec. 2, 2013, and incorporated by reference herein.

### TECHNICAL FIELD

This disclosure relates generally to online advertising, digital content creation and investments in content creation, and in particular, to advertising competitive and distinctive features, attributes, things or highlights in publicly visited places.

### BACKGROUND

The concepts of content creation, investment, and local place search systems and engines are generally well known. However, the present disclosure combines these techniques into a unified and elegant system which incorporates and unites the interests of different parties and helps them work together for a mutually beneficial outcome.

### BRIEF DESCRIPTION OF THE DRAWINGS

FIG. 1 is a block diagram of an exemplary ecosystem;

FIG. 2 is a flow diagram illustrating a process for content creation;

FIG. 3 is a flow diagram illustrating an advertising model that includes compensation for writers;

FIG. 4 is a flow diagram illustrating an investment model;

FIG. 5 is a flow diagram illustrating a process for content curation;

FIG. 6 is a flow diagram illustrating a BPV offer from the community guide;

FIG. 7 is a flow diagram illustrating a BPV offer from an investor;

FIG. 8 is a flow diagram illustrating a BPV offer from a merchant; and

FIG. 9 is a flow diagram illustrating a process for a merchant RPV campaign.

### DETAILED DESCRIPTION

The following disclosure describes a creative and interactive system and method for online advertising whereby an owner or manager of a “place” remunerates a writer who authors a story about the place based on the popularity of the story among visitors or clients of the place who vote for the story. In addition to rewarding writers, the system and method also provides a mechanism for rewarding content curators and supervisors who create or manage initial content development for a place. The system enables authors to publish stories in guides, as well the ability to curate, promote, and otherwise manage crowd-sourced content, which may be owned by the authors.

The system and method also includes a mechanism whereby investors can invest their own capital or external capital in the creation of digital content and in the acquisition of system users, and receive returns on their investments.

The system and method also provides a mechanism for searching highlights, stories, places, peers, and other relevant information. The search can be enhanced based on a likeness index that is computed for peer users of the system.

Detailed embodiments are disclosed herein with reference to the accompanying drawings. It should be understood that the disclosed embodiments are merely exemplary of the disclosed subject matter, which may be embodied in various forms. Therefore, specific structural and functional details disclosed herein are not to be construed as limiting, but merely as a basis for the claims and as a representative basis for teaching the subject matter to one skilled in the art. Various embodiments may be readily combined, without departing from the scope or spirit of the present disclosure.

1. Exemplary Ecosystem

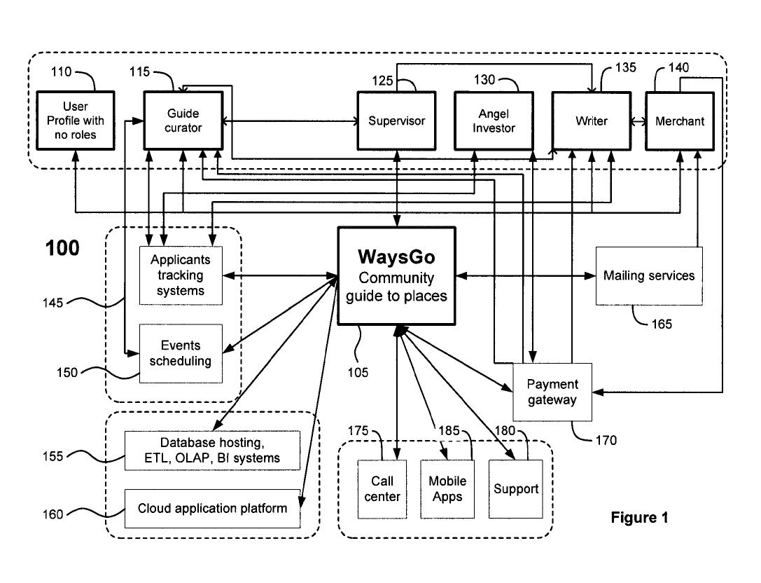

FIG. 1 is an exemplary ecosystem diagram of a system 100 for operating and maintaining a guide to places in a particular community. In one embodiment, the system 100 is implemented as the WaysGo® community guide 105, currently available as an online web-based service via the Internet at <https://www.waysgo.com>.

The system 100 includes multiple defined roles that operate within the system, including a user 110, a guide curator 115, a supervisor 125, an angel investor 130, a writer 135 and a merchant 140. The owner or manager of a place is hereinafter referred to as a merchant. The descriptions of various embodiments herein are intended to be illustrative and not limiting.

Any person can register as a user 110 in the system 100 if they accept the Terms of Service and the Privacy Policy of the system. In one embodiment, a user 110 who has visited or checked-in at a place, or “opened up” a place, listed in the community guide 105 can create and post a story about a relevant highlight or feature of that place. Such a user 110 becomes a writer 135 after publishing at least one story in the community guide 105.

Any writer 135 can apply through an applicant tracking system 145 to become a guide curator 115. Such a process requires screening, selection and approval. If the writer's application is rejected, they can apply again.

A guide curator 115 can create a plurality of guides for the system 100. A plurality of stories can be posted in any guide created by an approved guide curator 115. The guide curator can approve or reject stories submitted by writers for publication in a guide of the guide curator.

Any writer 135 can author a plurality of stories, but in one embodiment, a story can only be published in a single guide. In another embodiment, a story could be published outside of the community guides.

A story should be properly structured, for example, with the following information: title of the story; highlight associated with the story; description or text related to the selected highlight; and tags. Other information could be provided. Each story is tied to only one place.

A supervisor 125 is made responsible for content, e.g., stories and guides that are published in a selected region or a selected category. The supervisor 125 administers the community guide 105 at the highest level.

The supervisor 125 approves or rejects the applications of potential guide curators 115. Once such an application is approved, the applicant becomes a guide curator 115. Guide curators 115 can organize events using an events scheduling module 150 embedded in the system 100.

Any user 110 can claim ownership rights to a place in the system and become a merchant 140 after going through a validation process as described below.

The system 100 utilizes a mailing service 165 to attract and retain merchants within the system and/or to entice the merchants to use system resources for running advertising campaigns.

The system 100 utilizes payment gateways 170 and payment processing services of outside providers to accept payments from merchants 140, and to make payments to writers 135. The system can withhold service fees from the payments to merchants 140 or from the earnings of writers 135 for using the payment processing capabilities of outside providers.

The system utilizes outside providers to establish a call center 175 and relevant support 180 for the system 100. Mobile applications on various handheld electronic devices can also utilize a portion or the entire functionality of the system.

2. Content Creation

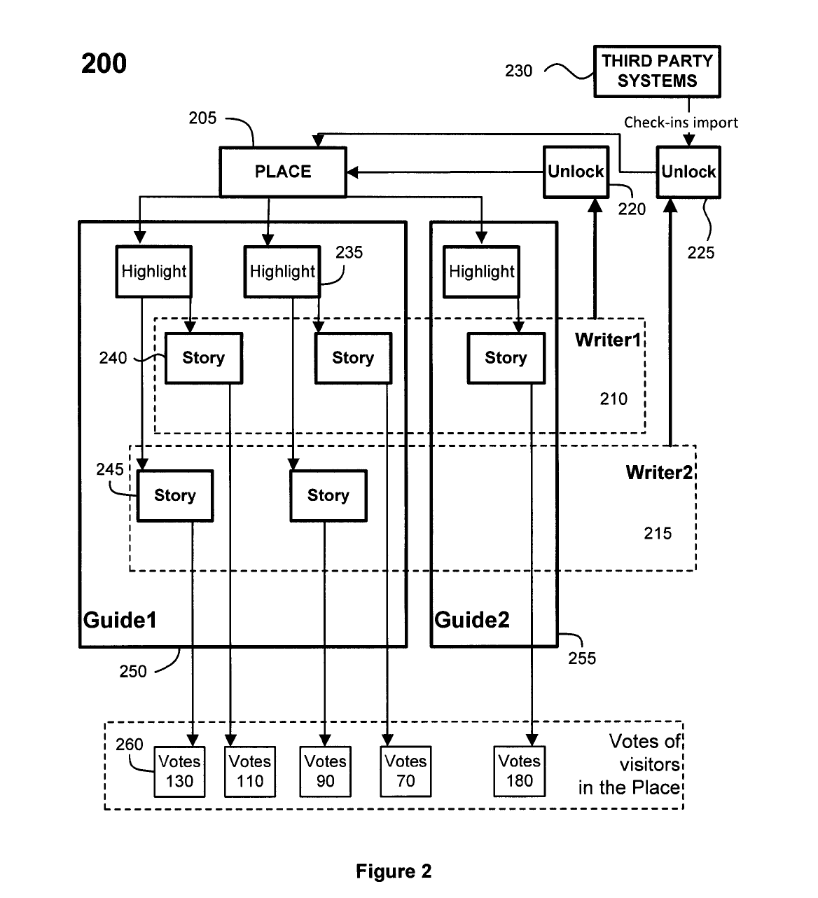

FIG. 2 is a flow diagram illustrating one embodiment of a content creation process 200. A first writer 210 and/or a second writer 215 can create or select any highlight 235 of a place 205 listed in the community guide 105. For the selected highlight, the first writer 210 can create a story 240 and/or the second writer 215 can create a story 245, and the stories can be posted at the community guide 105. The writer has to “open up” (or “unlock”) 220 or 225 the place 205 in order to create and post a story. In one embodiment, the User 110 has to be physically present in the place 205 to “unlock” (“open up”) 220 or 225 or “check-in” to that place. In another embodiment, the User 110 can import check-in information from a third party system 230 which is integrated with the community guide system.

Typically, every story must be posted in a previously created community guide, such as guide 250 or guide 255, which may have been created by the same user or by a different user. However, stories could also be posted outside of the community guides.

The guide should have a predetermined structure, for example, including the name of the guide, at least one picture reflecting the essential characteristics or content of the guide, and tags specifying the content and linking other users to the guide through the community guide system.

A story should have a title, at least one picture directly related or otherwise pertaining to the content of the story, tags linking the story to the users, guides, categories, and places through the community guide system.

A profile of the place can contain a variety of information related to the business or operations of the place, such as: name of the place, address, telephone and fax numbers, e-mail address, web site, social links, pricing, business hours, holiday hours, or any other information pertaining to the place. The place profile may be linked to a plurality of guides and to stories published in those guides, although the stories could also be published outside of the guides.

The models described herein for creating digital content and advertising enable merchants to reach their target audience and track results as well as create and shape their digital presence in the community guide system.

Any user 110 can submit a vote 260 for a story, such as story 240 and/or story 245, that is posted and published in the community guide system if that user also unlocked that place and is not the author of that story.

3. Writer Earnings Business Model

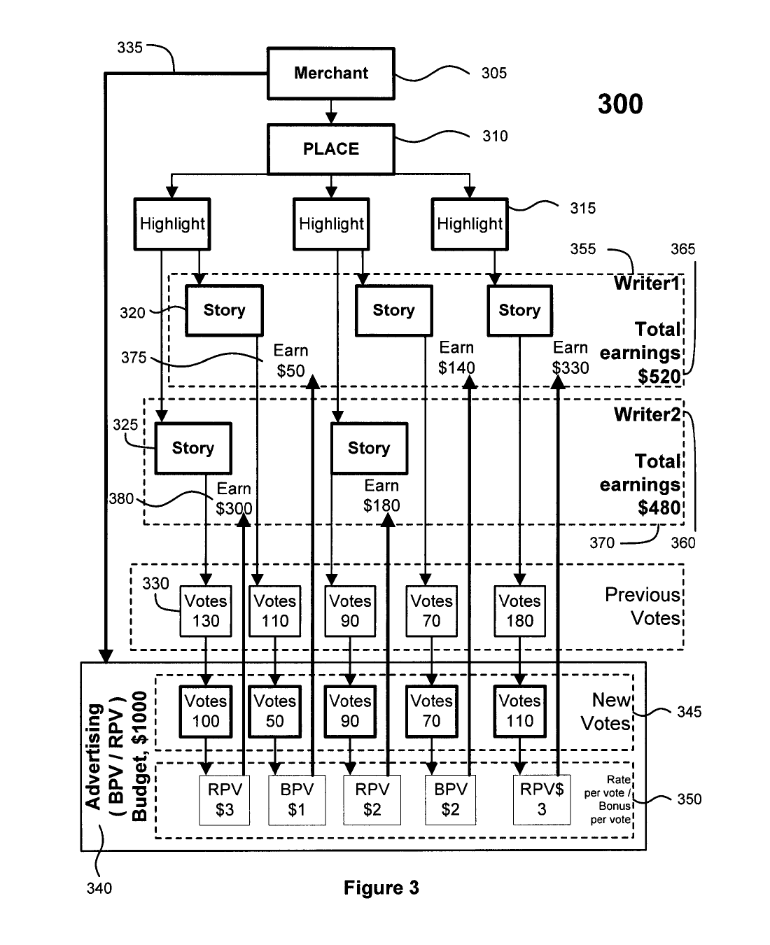

FIG. 3 is a flow diagram illustrating one embodiment of a model for business advertising and remunerating writers. Merchant 305, who is the owner or a manager of a place 310, remunerates a first writer 355 and a second writer 360 for original, creative, and popular written stories, such as story 320 and story 325, about highlights 315, such as distinctive goods, services, or attributes, in the place.

In order to run an online advertising campaign 300. the Merchant 305 can select the most popular stories, such as story 320 and story 325, based on the number of votes 330 given to the stories by the visitors and customers of place 310. The Merchant 305 deposits 335 an advertising budget 340 into the community guide system, and the system administers all interactions among users and provides a platform for online advertising. Whenever a user submits a vote 345 for the advertised stories, such as story 320 or story 325, the author of the story (i.e., writer 355 or writer 360) earns a royalty as fee 375 or fee 380, which is added to the total earnings 365 or 370 of the writers 355 and 360, respectively.

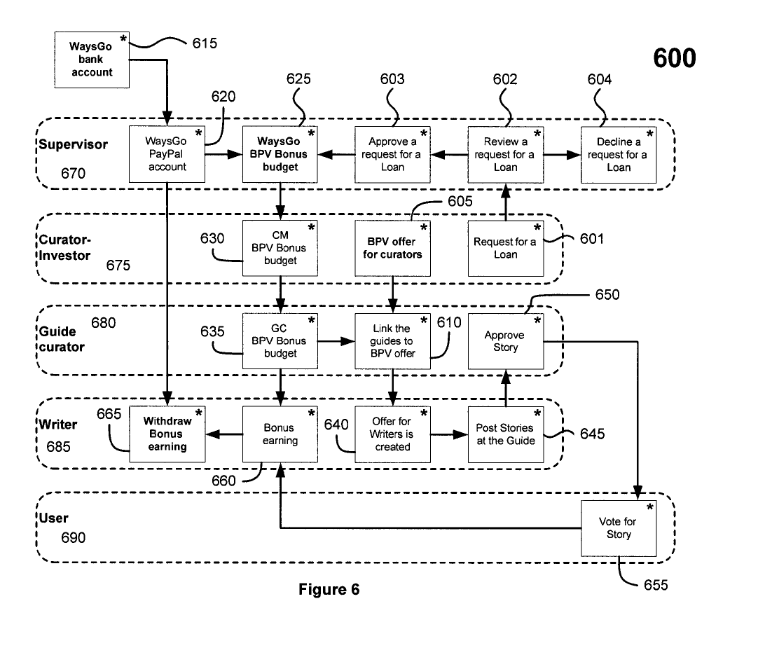

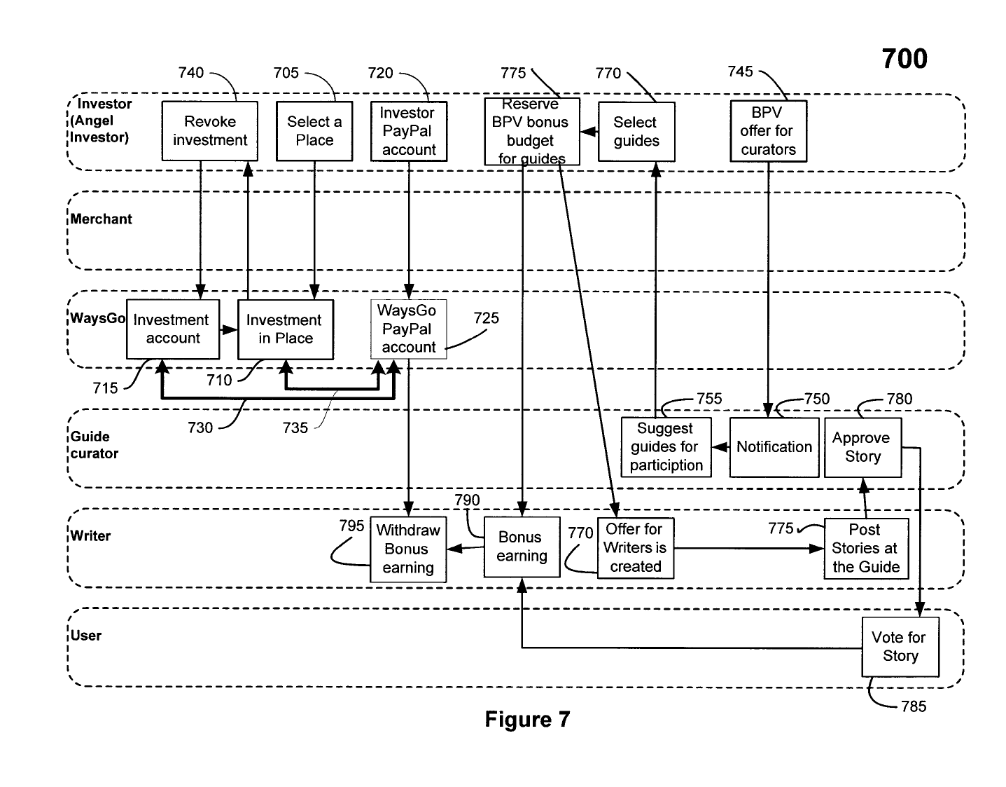

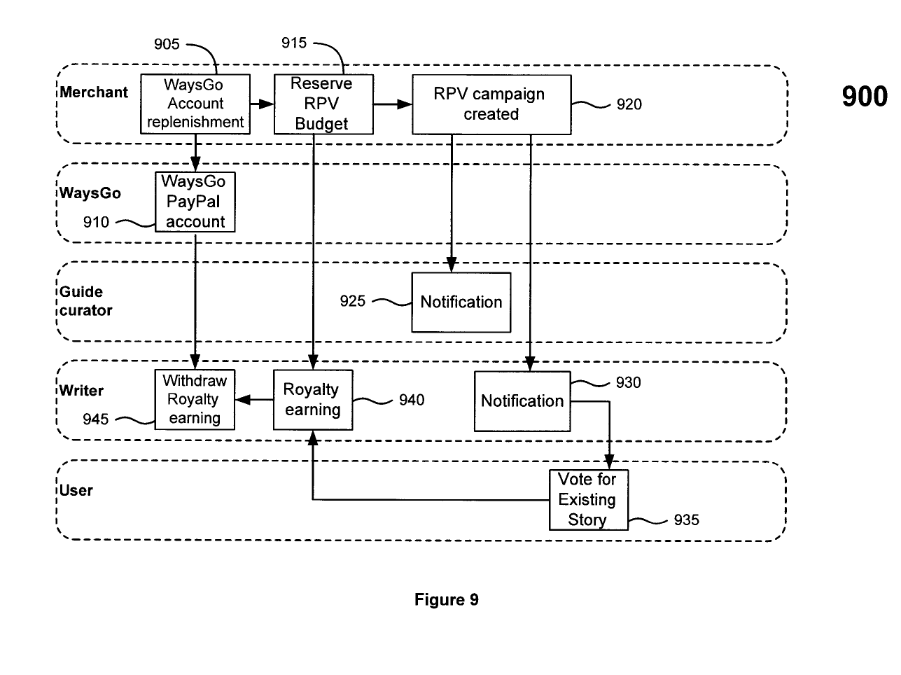

The value of a single vote can be predetermined, for example, based on the bonus-per-vote (“BPV”) rate set by a supervisor (see FIG. 6), or an angel investor (see FIG. 7), or a merchant 305. Alternatively, the value of a single vote could be automatically counted based on a rate-per-vote (“RPV”) 350 model described below (see FIG. 9).

The system can be configured to withhold a service fee from the merchants or from the earnings of the writers. Alternatively, the system can pay the third parties or other users of the system for their facilitation in the entire process of advertising, curating, moderating, or otherwise managing the content and the process flow.

For example, a merchant 305 may pay $1000 toward an advertising budget 340 on the system. The merchant 305 then selects five stories 320 and 325 about three highlights 315 created by two writers 355 and 360. The RPV 350 for each story can be determined as described herein. The writers 355 and 360 can earn royalty fees 365 and 370 in the amount of $520 and $480, respectively, for the new votes 345.

4. Investment Business Model

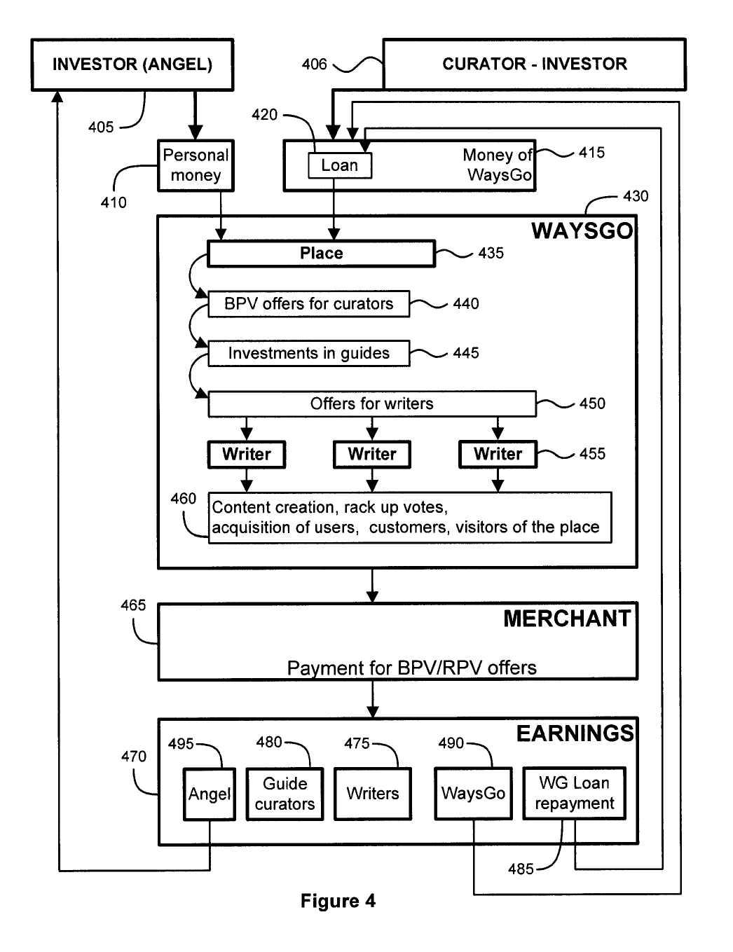

FIG. 4 is a schematic flow diagram illustrating one embodiment of a model for business investment in the community guide system. There may be various different resources for investment of bonus budget money, including the financial resources 415 of the community guide, cash 410 from external investors 405, payments of the merchants for BPV offers 465, and earnings 490 which the community guide system receives as a service fee. The simplified investment model can be construed as a way to invest capital into the community guide system and obtain a return on the invested capital.

In general, there may be two types of investors: those who invest their personal finances 410 and those who invest the financial resources of the community guide 415. If a user is investing personal capital 410 in the system, the investor is considered to be an individual investor or an angel investor 405.

The community guide can hire employees or independent contractors, such as Supervisor 406, to manage the investments using the financial resources of the community guide. In one example, the financial resources can be in the form of a loan 420 which must be paid back to the community guide on the terms specified in system policies.

In a typical embodiment, a single place 435 can have only one investor 405 or 406. The money received from all sources 410, 420 and 425, can be invested in any place 435 which is listed in the community guide system and is not yet taken over by other investors. However, an investor 405 or 406 can reject the place 435 and withhold all invested amounts in the place only if the investor does not have any investments in any other guides 445 (hereinafter referred to as a “conditional investment in a guide”) for that place 435. If a place is rejected and abandoned by one investor, it remains available to be taken and invested in by another investor.

If the investor rejects a place 435, the investor can move the invested amount that has been withheld from the rejected or refused place to the personal investment account of the investor at the community guide, and those funds may be used for further investments in other places listed in the system.

In one example, the money received from all sources 410, 420 can be invested in a place 435 in the following order: the amount of the loans 420 must be invested first by an investor 406, and then the personal money 410 of an investor 405 can be invested.

When a place 435 has been taken over by an investor, the investor can create a BPV offer 440 for curators as described with reference to FIGS. 6-8 below.

When an investor selects and makes investments 445 in selected guides, the investor is barred from thereafter rejecting and abandoning the place. When an investment is made in guide 445, offers 450 are created for writers and sent to subscribed writers 455. When writers accept the offer, they create highlights 460 and post stories to the system and rack up the votes of the customers and visitors of the respective place 435 to which the offer 450 is tied.

When a place has an adequate number of highlights, stories, customers or visitors, the merchant of the place might be interested in investing in advertising of the place in order to get more interesting and useful stories and thereby attract new customers while retaining existing customers. Thus, the merchant can start paying 465 for such advertising, and the advertising proceeds can be used to (i) remunerate the writers 455 who authored the stories, (ii) pay fees to guide curators who managed the respective guides wherein stories were posted and published, (iii) pay returns to angel investors 405 and supervisors 406 who invested personal money 410 and the money of the community guide 415, respectively, and (iv) pay a service fee to the community guide system.

The rules and percentages for splitting proceeds which come from the merchants' payments can be defined in the system policies. As one example, the BPV proceeds may be split as follows: from an angel investor or curator-investor, the BPV is distributed 100% to the writer and all other roles get nothing; from a merchant, the BPV is again distributed 100% to the writer, however, the guide curator gets from 5% up to 15% from Merchant BPV value which is paid in the form of a BPV fee, the rest of the proceeds is counted as the system fee revenue. As another example, the RPV proceeds may be distributed as follows: the writer gets from 60-70% of the merchant's BPV value, while the guide curator gets from 5% up to 15% of the merchant's BPV value, and the rest of the proceeds are counted as system fee revenue.

5. Content Curation

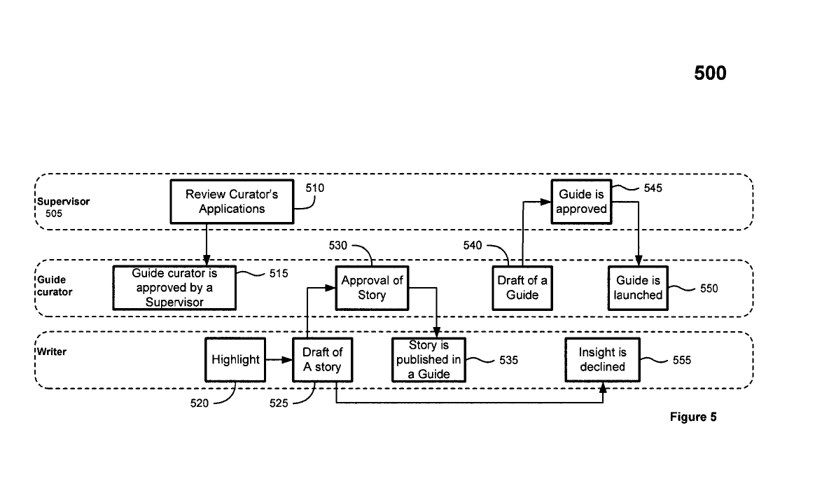

FIG. 5 is a schematic flow diagram illustrating a process 500 for curating content, where a number of user roles, responsibilities and functionality are defined.

For example, supervisor 505 (or a user with other responsibilities) can have a number of defined responsibilities which can be shared among all supervisors as follows:
(i) Processing applications from potential guide curators—the supervisor can approve or reject a guide curator depending on whether the applicant complies with the system requirements. The supervisor can also suspend the account of an unqualified guide curator or of a guide curator that has violated the system policies and guidelines;
(ii) Monitoring and correcting guides of curators—can be based on groups;
(iii) Setting up royalty values in the guides of curators or in the place groups;
(iv) Supervising the life cycle and client relationship with the places which belong to the regions and categories or groups for which the Supervisor is responsible;
(v) Supervising the content of the guides covering the places which belong to the regions and categories for which the Supervisor is responsible;
(vi) Responding to help requests from curators and chatting with such curators;
(vii) Arranging and sending letters of invitation to the merchants of the qualified places which belong to the regions and categories or groups for which the Supervisor is responsible. The qualified places can be determined based on metrics of the community guide system. In another embodiment, a letter of invitation can be sent to the merchant when the merchant requests such a letter in the ownership claim process;
(viii) Communicating with the merchants, and coordinating efforts with the customer support team.

In one embodiment, the supervisor 505 reviews applications 510 to be a guide curator, and approves or rejects the applications based on system policies and guidelines. For example, a user may create a draft guide with specified tags, and submit the draft guide with an application form including personal credentials, e.g. first and last name, city or location, login identity or nickname. The community guide system sends a message, such as an SMS message, having a code which an approved curator is required to enter as proof of a guide curator role. Then, the guide curator can create drafts of the guides 540 and submit the drafts to the supervisor 505 for approval 545. When the guide is approved 545, it can be launched 550 in the community guide system.

Any user 110 in the system can create new highlights 520, or use highlights previously created by other users. When a user unlocks a place, the user can create a draft story 525 and submit it for publication in any guide which covers such a place. The guide curator for that place can either approve the story for publication 530 or reject the draft 555. Once the story is approved, it is published 535 in a respective guide, and the user gets a role of a writer in the system.

However, if the author/writer of the story violates any rules of the community guide or the system policies, the writer may be banned, for example, by the guide curator or the supervisor, if so stipulated by the policies of the system. Under certain circumstances, if the writer is paid for the stories, then there could be different approaches to curating the quality of stories submitted by the writer.

6. Community Investment Process with BPV Offer

FIG. 6 is a flow diagram illustrating a process 600 for generating a bonus-per-vote (“BPV”) offer that originates as an investment from the community guide itself.

For example, a supervisor 670 at the community guide can deposit bonus budget money 625, obtained from various resources, to a bank account 615 that is linked to the payment processing system and/or payment gateway 170 embedded with the community guide system. The bonus budget money can thus be used for creating content and for community development in the system by means of remunerating writers 685 for creating and posting stories 645 in the community guide while users 690 vote for the stories 645. The bonus budget 625 can be formed by the financial resources of the community guide system 415, for example, in the form of loans 420 and earnings 490 received as service fees. The bonus budget 625 can be physically kept with the bank account 615, or on the PayPal account 620, or in other payment systems associated with the community guide as appropriate.

A Curator-Investor 675 can send a request for a loan 601 to a supervisor 670. The supervisor can either approve 603 or decline 604 the loan request. If there are available financial resources, the supervisor 670 can reserve money to the subordinate (or dependent) Curator-Investor (and/or a community editor) 675.

When a Curator-Investor 675 has available bonus budget, he or she can reserve the whole or a part of the available amount to the guide curators 680, which have previously been approved 515 at the community guide system. Once there are available financial resources, the Curator-Investor 675 can start a community guide bonus-per-vote offer 605 for other curators.

The structure of the BPV offer can include place details, a bonus-per-vote monetary value, and a brief note regarding the offer, for example, written by a supervisor.

One process for creating and executing the BPV offer is as follows:

Step 1: the Curator-Investor 675 creates a BPV offer 605 for other guide-curators 680;

Step 2: other guide curators 680 link their guides 610 to the BPV offer 605;

Step 3: a different Offer 640 is created for writers 685;

Step 4: a Writer 685 creates and posts a story 645;

Step 5: the Story 645 is approved 650, published, and the writer paid 660 for corresponding votes 655 for the story.

A more detailed description of the BPV offer process is as follows:

Step 1: Curator-Investor 675 creates a BPV offer 605 for other curators.

The Curator-Investor 675 selects a place 435 listed at the community guide, and creates a BPV offer 605 for other Guide-Curators 680 and Users 685 who have drafted guides and who want to become Guide-Curators 680. The place 435 can normally be identified by tags indicating place and category. Notification about BPV offers in the place can be sent in the form of a link to a “chat room” to those guide curators 680 and users 685 who are subscribed to selected geographic locations, categories, and places (i.e., they have selected the same tags as in the place 435 as their content preference);

Step 2: Guide-Curators 680 link their guides 610 to the offer.

Guide-Curators 680 can link 610 their guides to the active BPV offer 605, if they have a sufficient bonus budget 635, and they reserve a bonus budget for each guide they link. As an example of system policies, the guide bonus budget cannot exceed the bonus budget 635 available to Guide-Curator and the bonus budget must be a multiple of the BPV rate value set by the Curator-Investor 675 for that BPV offer 605;

Step 3: An offer for writers 685 is created.

An offer 640 can be created for writers 685 for each linked Guide. In one example, a writers' offer can be automatically created when a Guide-Curators links a Guide to a BPV offer. A “Guide chat-room” can also be created including a curator's note describing the offer, and all subscribed writers 685 and other relevant users 690 can be notified and invited to post their new stories 645 regarding the selected place.

Step 4: Writer 685 creates and posts a story 645.

A Writer 685 can “check-in” or “Unlock” or “open-up” the place 435, then create and submit a story 645 for any associated Guide which has an active offer 640 for writers 685. The writer 685 can “check-in” or “unlock” the place when the place is visited for the first time and the system is informed about the visit, for example, by clicking a button in the mobile application. The Guide-Curator 680 can approve 530 or decline 555 the story. The Writers 685 can be informed about guide content policy and eligibility requirements in the Offer which generally includes a description of the Guide and a brief curator's note, or in an ‘About” tab, for example.

Step 5: Story is approved, published, and paid for votes.

When the story is approved 530 and published in the community guide, any user of the guide can vote 655 for it. For each such vote 655, the writer 685 who authored the new story under the active Offer for writers 640, can be paid 660 a fixed amount of BPV 350 within available budgets.

Some logical restrictions could be applied, e.g.: (1) a vote by a Guide-Curator cannot be paid for stories published in the guide of that curator; 2) a Writer can post as many stories in a single guide as needed, and every vote will be counted only once for each story per voting user; (3) a Writer can get only one paid vote per each unique voting user per guide; (4) if a writer has different stories posted in different guides, and the guides have open offers for writers in the same place, then the writer can be paid for each unique vote in every such guide; and (5) a place can have only one active BPV offer for curators at a time.

In one embodiment, the bonus offer for curators and corresponding offer for writers can be revoked or terminated under the following circumstances. Curator-Investor 675 can revoke the BPV offer 605 for curators at any time. After the BPV offer for curators is revoked, guides can no longer be linked to the offer, and communications between Curator-Investor and the Guide-Curator via the chat room are closed and not available for further discussions. All related Offers for writers could still remain active until their guide bonus budgets are used, at which time the offer 640 for writers is terminated. The offer for writers 640 can also be terminated when a merchant 465 creates his BPV offer 805 for curators for that guide or runs an RPV campaign 920 in his place, and all stories created while that Offer for Writers 640 was active are paid from the previously reserved and remaining guide bonus budget.

7. Angel Investment Process with BPV Offer

FIG. 7 is a flow diagram illustrating a process 700 for generating a BPV offer that originates with an investment by an individual or ‘Angel’ investor.

It is contemplated that individual users could invest their own personal money in the community guide system and get a return on their investment on terms specified in the terms of service, payment policy and/or other legal documents specified in the community guide system. For example, an investment can be made for creating content in the system and for payment to writers and content managers. The user account could belong to any individual or legal entity. Such an investor will be called an ‘Angel investor’ herein.

A user can select and invest in a place 705 listed in the community guide, and that place will be considered ‘taken’. The investment funds may be sourced, for example, from an external payment system account personal to the investor, e.g. PayPal account 720, or from an investment account 715 which accumulates earnings of the user. The system may also return funds to a user account when the user withdraws from another place 740 in which the user had previously invested. In either case, the money can physically be kept at a user payment account in the system, e.g., PayPal account 725.

Once an investor invests a minimum amount required for a specific place, the investor can create a BPV offer for curators 745, and all subscribed users and guide curators are notified 750 about the offer. The offer for curators can be created and executed, applicable restrictions as necessary, similar to the process described with reference to FIG. 6, with a significant difference—the supervisor/editor can invest only the investment money provided by the community guide system, and the angel investor can invest only personal or earned money.

When guide curators get offer notifications 750, they can suggest guides 755 for participation in the offers. The angel investor can select 770 a number of the most interesting guides at their personal discretion for participation in the offer, and should reserve a BPV budget 775 for each selected guide with a total investment amount not exceeding the amount invested in the participating place and the amount reserved for BPV offer. When a BPV budget amount is reserved for participation in the offer, an offer for writers 770 is automatically created and sent to the writers who are subscribed to the guides participating in the BPV offer created by the angel investor.

Any writer can create and submit a story 775 for inclusion in the participating guide. The writer can submit a story which was previously created and saved as a draft. The guide curator can review the submitted story and approve 780 or decline it.

Any other user can unlock the place and vote 785 for the story created by the authoring writer. While there is an available bonus budget amount 775 at the participating guide, the qualified story of the authoring writer can be remunerated or rewarded with a bonus amount equal to the value of the vote 790 as set up in the BPV offer.

The writer who earned BPV money in the system could withdraw the earnings 795, or move those earning to the writer's personal investment account (if the writer also has the role of an angel investor in the system), or move those earnings to a merchant's investment account if the user also has the role of a merchant in the system.

8. Advertising Business Model with BPV Offer

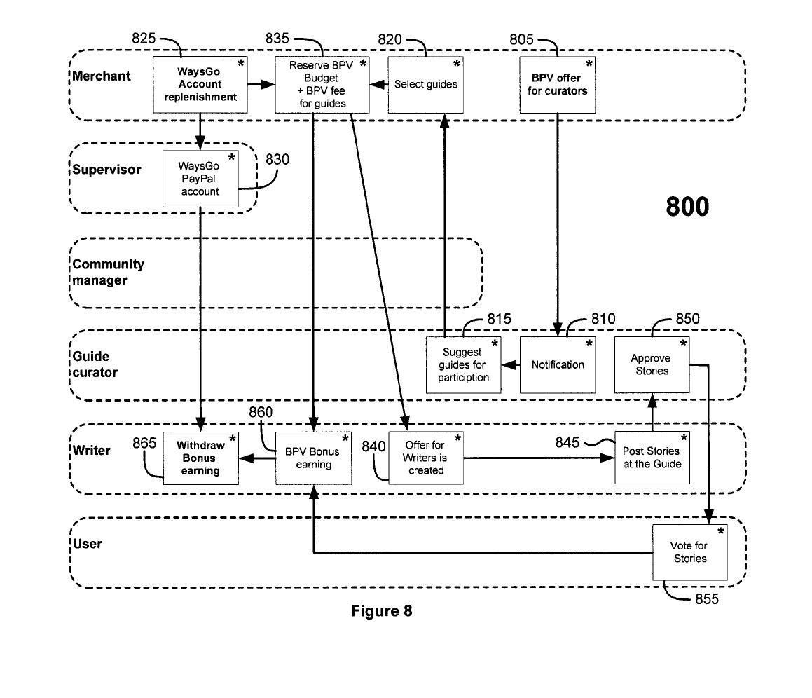

FIG. 8 is a flow diagram illustrating a process 800 for generating a BPV offer that originates with a merchant. A merchant can also invest personal money in the community guide system on the terms specified in the terms of service, payment policy and/or other legal documents. The investment can be made for creating content in the system and for payment to writers and content managers. The user account can belong to any individual or legal entity.

There are many benefits for the merchant related to investing in a personal place, such as the creation of new content covering the highlights in the place, the acquisition of new customers and visitors, and achieving accolades in the form of votes given by various customers and visitors in that place.

When a merchant claims ownership of a place and confirms it, all BPV offers previously created by other investors are closed. Any money still invested in the guides by the previous investors can be distributed only to those writers who posted their stories in those guides when the offers were active. At the same time, however, any newly created stories posted in the guides under the BPV offers created by the merchant can be remunerated under merchant BPV offer model.

The merchant can replenish a personal investment account and then reserve an amount for a BPV offer 805 for curators. Once the previous BPV offer is closed, a new BPV offer for curators can be created by the merchant. When the merchant creates a BPV offer for curators 805, all subscribed users and guide curators are notified 810 of the offer.

When guide curators get offer notifications 810, they can suggest guides 815 to the merchant for participation in the guide offers. The merchant can select 820 a number of the most interesting guides at their personal discretion for participation in the offer, and should reserve a BPV budget 835 for each selected guide with a total investment amount not to exceed the amount reserved for BPV offer. Along with the BPV budget, the merchant has to reserve a BPV offer fee for each BPV offer created. When a BPV budget amount is reserved for participation in the offer, an offer for writers 840 is automatically created and sent to the writers who are subscribed to the guides participating in the BPV offer created by the merchant investor.

Any writer can create and submit a story 845 in the participating guide. The writer can submit a story which was previously created and saved as a draft. The guide curator can review the submitted story and approve 850 or reject it.

Any other user can unlock the place and vote 855 for the story created by the authoring writer. While there is an available bonus budget amount 835 at the participating guide, the qualified story of the authoring writer can be remunerated or rewarded with a bonus amount equal to the value of the vote 860 as set up in the BPV offer.

The writer who earned BPV money in the system can withdraw the earnings 865, move those earning to a personal investment account if the user has the role of an angel investor in the system, or move those earnings to a merchant's investment account if the user has the role of a merchant in the system.

One example of a process for creating and executing a merchant BPV offer for curators is as follows:

Step 1: The merchant creates a BPV offer for curators, and reserves an amount for BPV offer and BPV offer fee.

Step 2: All subscribed and approved guide curators are automatically and instantaneously notified about the merchant's BPV offer.

Step 3: An interested guide curator selects his guide, creates a curator's note to that guide, and sends a request to the merchant to link one or more of his guides to the merchant's BPV offer. Automatically and instantaneously, a “merchant-guide curator's chat-room” is created for communicating and sharing information with interested parties.

Step 4: The merchant selects interesting guides, and reserves required bonus amounts to each guide, as well as an additional bonus fee, e.g. 30%, all of which are paid from the merchant's balance at his community guide account. An offer for writers is created for each guide selected and paid for by the merchant. The merchant can replenish his balance at his community guide account by paying via an embedded or external payment system, e.g., via PayPal.

Step 5: The writer can now create and submit stories to any guide with prior approval by the guide curator.

The writer will be paid for votes in accordance with applicable terms and restrictions. Further, the guide curator is also paid for each vote paid to writers for stories in his guide, e.g., 10% of the BPV value. The BPV offer is closed when the merchant closes the BPV offer or when all budgeted money in the BPV offer is used for payments. The rates for the BPV offer fee and the guide curator fee can be set to be different from those mentioned above.

9. Advertising Business Model with RPV Campaign

FIG. 9 is a flow diagram illustrating a process 900 for generating a merchant rate-per-vote (“RPV”) campaign. The merchant RPV campaign is one of the key elements of the advertising business model.

A merchant can replenish 905 his/her account in the community guide system via payment of any amount to the system. The payment can be done through the PayPal payment system, and money paid by the merchant will be kept at the PayPal account 910 of the system until the funds are used for advertising or refunded to the merchant according to the terms and conditions of the system.

When the merchant has a required amount, the merchant can reserve an RPV budget 915 for further RPV campaigns, also known as advertising campaigns. The major purpose of the merchant RPV campaigns is to advertise and popularize the stories which have previously been created by the writers in the community guide system. Among the merchant's benefits for launching an RPV campaign are: attracting new customers and visitors to the place; making customers and visitors feel more interconnected based on their mutual interests; and improving and enhancing the visibility in the search results for such a place and related highlights and stories in the community guide system.

When the merchant creates an RPV campaign 920, all subscribed guide curators and writers who authored the stories selected by the merchant for participation in the RPV campaign can be notified 925 and 930 that the RPV campaign in that place has begun.

The merchant configures the settings and parameters of the RPV campaign which will be launched. For example, the structure of the merchant RPV campaign can be to select stories, then allocate a budget. The merchant can set a range having a minimum rate R(min) and a maximum rate R(max) for any RPV campaign, and stories with these RPV values will be paid for by votes of the users, i.e., stories with RPV values in the defined range will participate in RPV campaign of the merchant. In one embodiment, the width of the limits is set as R(max)−R(min)=>R(max)*10% with a step of $0.01. The RPV campaign can be started when the campaign budget is 10 times larger than the sum of RPV values of all stories that are qualified for participation in the RPV campaign.

RPV is a variable which can be a function, e.g., an exponential function of a “likeness index” and a “highlight rating.” RPV can become a fixed value or be frozen at a value when the merchant starts an RPV campaign. If the merchant stops the RPV campaign and then starts it again, or starts a different RPV campaign, the RPV value for the new campaign can be revaluated based on a variety of factors including internal dynamics of the community guide system for counting RPV values.

In one embodiment, the following mechanism can be used for forming an RPV value: any story which has already received at least one vote will be assigned an internally calculated value of RPV, which can be calculated as a function of the BPV. The RPV can change the value according to a mathematical formula which can be implemented in the community guide system and updated as necessary. After the merchant's BPV offer for the guide is closed, the current values of the RPV can be shown to a user having the roles of merchant, curator, and writer. The same RPV values can remain valid for angel investors and for curator-investors, and in that case, the investor can see the RPV values for all stories created with help of his/her investments in the place. When a merchant claims and proves up ownership rights in the place, the merchant can create RPV campaigns for all stories which used the BPV budgets that were previously reserved.

The RPV campaign can be stopped by the merchant at any time at the discretion of the merchant or when there are no longer sufficient funds for the RPV campaign.

In one embodiment, when the RPV budget of the campaign is reduced by three times from an initial campaign budget, then the merchant is notified by the system that the RPV budget has reached a predetermined minimum and should be replenished if the merchant wants to proceed with an existing RPV campaign.

9. Peers, Likeness Index, Highlight Rating, Value, Popularity, and Place Groups

The following definitions are used in one embodiment of the community guide system”

“Peers” are system users that vote for the similar highlights. A number of highlights can be attributed to the same place which users occasionally visit or used to visit.

The “likeness index” is a measure of similarity for profiles of two independent users in the system, and reveals users who vote for the same stories in the same places. The likeness index can be calculated based on user profile data, number of voted highlights, number of voted stories, number of voted places, number of coinciding stories, number of coinciding highlights, number of coinciding places, and other similar factors.

The “highlight rate” is a measure of popularity of a specific highlight in the community guide system. The highlight rate can be defined as a cumulative number of all votes given to all stories which contain the highlight. A badge may be allocated near the popular highlight to show the position number of the highlight in a search result. The merchant of the place can treat the popularity of highlights based on highlight rates as a competitive advantage of that place. Therefore, in one embodiment, the advertising business model can be used as a tool for the merchants to invest capital in order to raise the rates and popularity of their stories, highlights, and thus, of the place itself. Users can compare and contrast the highlights with different rates, and see the most popular highlights, stories, and places.

The “value of a place” can be determined as the sum of values of all highlights or of all stories related to the place. In one embodiment, the value of a place can be determined by system supervisor based on tier groups which can be predetermined in the community guide system.

The “popularity of a place” can be determined by the number of customers or visitors that have unlocked that place. In one embodiment, the popularity of a place can be determined as a growing function which depends on various factors, such as the following metrics: the number of unique users in the system who viewed the place, its highlights or stories (views variable); the number of unique check-ins to the system (check-ins); the number of users who have “pinned” the place (not counting guide curators)(pins); the number of guide curators who have pinned the place (c-pin); the number of pictures in the place added by users (photo); and the number of story drafts created but not yet published by writers (drafts). Other variables can be added, or be replaced by other variables, and the sequence and importance of the variables can change.

A “group of places” can be used to coordinate the efforts of a supervisor in the community guide system. In one embodiment, groups can be created and managed by a supervisor. Whether a place belongs to a group can be determined by incorporating tags, locations and/or categories. Each group can be configured with predetermined values by the supervisor, such as BPV (min), BPV (max), RPV (min), and RPV(max). The supervisor can set the initial values of BPV (min) and BPV (max) for each group.

The “value of a place” can depend on the popularity of a place, and this value can change in a non-linear fashion from RPV(min) to RPV(max) depending on the place “popularity index.”

When a place gets invested in by an angel investor or by a supervisor, then the value of the place is fixed and the invested amount is forwarded to the place investment account of the investor. Further, the value and popularity of the place is hidden, and calculations of the value and popularity is stopped when the first guide in that place has been invested in. If the investor eventually refuses the place, the system can renew the visibility of the place value and the place popularity.

10. Web-Places with Online Presence Only

Although this disclosure contemplates primarily brick-and-mortar places which have physical locations, it is possible for web-places to be listed in the community guide system. For example, web places can have the same functionality and possibility for advertising and content creation in the community guide system as regular physical places. Further, there is also a possibility that web places may have specific functionality which is only available at the web places.

11. Model for Attracting Writers, Guide Curators, Investors, Merchants

In general, the viral model will drive the acquisition of new users in the community guide system. The mechanics for paying for votes embedded in the system will significantly impact the acquisition of early adopters and the retention of existing users.

Users who are already registered in the system can be motivated to become writers and guide curators with help of financial and non-financial incentives. The financial incentives can include payments for creating and posting original stories and/or launching and curating guides in the system. Non-financial incentives can include the possibility of attracting a wide audience of followers, readers, customers, visitors, etc.; creating a popular public profile; finding peer users in the system who have more or less similar preferences and habits; and analyzing the dynamics of customers and visitors in dashboards and other analytical tools that can be embedded in the system.

Potential writers and guide curators can be invited to the system via internal or external job posting boards as well as applicant tracking systems, sites, resources, and social media job postings.

Investors can be attracted to the system using the same tools for inviting writers and curators as well as other methods, e.g., via web sites which are specialized for private or angel investors and other investment vehicle resources. Merchants can be attracted to the system using the same tools for inviting writers and curators as well as other methods, e.g., via web sites which are specialized for communicating and sharing messages and invitations to and among the owners or managers of places.

12. Place ownership validation process

A merchant who is the owner or a manager of a place is required to prove up ownership rights in the place, and several tools may be provided for the owner or manager of the place to do so.

In one embodiment, the user has an account at the community guide and must be logged into the system to start the process of claiming ownership rights in the place. The process for claiming ownership rights is self-guided and self-explanatory. The user can update the contact details on the profile of the place, then click a “Claim” button. In one embodiment, the system then sends a code to the mobile phone listed by the user in the system, and the user is requested to enter that code for verification purposes.

A second step can be included in the verification process, e.g., the system sends a Letter of Invitation to the address of the user entered in the profile of the place. The Letter of Invitation can also include an invitation code which the user has to enter into the claim form. If the user has not received a Letter of Invitation, he/she can request that the system send one to the indicated address again. There may also be a requirement to deposit a minimum value amount into the system to create a BPV offer for curators or to start an RPV campaign in the system. In one embodiment, if the merchant pays the required minimum amount, the requirement to enter an invitation code from the Letter of Invitation may be waived.

Any system user can claim ownership rights in a place. If there are any conflicts among managers or owners of the place, then additional ownership verification procedures can be undertaken.

13. Description of Important Use Case Scenarios

The following describes various important use case scenarios:

An investor can buy a place using a PayPal account. If an investor leaves a place that he has previously purchased, then the money is refunded to his/her PayPal account. A logical restriction on such a transaction is a limitation of 60 days within which the investor can leave the place. Further, the investor can leave the place only if he/she did not make any offers related to the place.

A curator can request a loan from the community guide, and if approved, the curator can invest in any place, just like any other investor. The curator is needed to initialize content for places listed in the community guide, to monitor user traffic and related votes for stories.

The community guide will configure a set of metrics based on which the activity in any place can be measured and invites can be generated and sent to those having an interest in the place.

A merchant, i.e., an owner or a manager of a place, can claim ownership in the Place without the need to pay any monthly, annual fees.

In general, there are two types of owners at the community guide: a “pre-owner” and an “owner.” A pre-owner is a user that has claimed inherent ownership rights in the place, and there can be only a few such users. An owner is a user that has claimed ownership rights and has paid an amount equaling an initial investment that was invested by another investor in the Place.

Because offers can be created by both investors and merchants, the bonus budgets may be further split among the various offers. However, any offer is closed when the budget is depleted.

The RPV value is assigned based on a BPV value, and with additional voting, the rate will typically rise. Thus, the more frequently a user votes for a story, the more “like-minded persons” a user can find at the community guide, and the story will get a higher RPV value. In one embodiment, the RPV value is a function that depends on the number of votes and the number of like-minded persons. When a user votes for a story, the budget of a campaign related to the story decreases by the RPV value.

Merchants can promote existing stories while creating new promotional campaigns at the community guide. For example, the merchant can identify the lowest and the highest RPV values with help of a digital slider tool which can be fixed in three positions, such as a 1-300 likeness index, a 100-300 likeness index, and a 200-300 likeness index.

When a merchant pays for a promotional campaign at his/her place, the merchant also has to pay a premium above the price, e.g., 30%, which will be paid for by votes in the campaign.

In one embodiment, when any user votes for a story for which there is a BPV or RPV payment, the story can be marked with a lighted star. However, when somebody votes for the story and there is no BPV or RPV payment for it, then the star is turned off.

The systems and methods described herein can be implemented in desktop or mobile applications which incorporate all the key functionality described above and use all the community application data synchronously.

While one or more implementations have been described by way of example and in terms of specific embodiments, it should be understood that the disclosure is not limited to the disclosed embodiments. To the contrary, this disclosure is intended to cover various modifications and similar arrangements as would be apparent to those skilled in the art. Therefore, the scope of the appended claims should be accorded the broadest interpretation so as to encompass all such modifications and similar arrangements.

1. A method for creating and promoting digital content, comprising:
publishing a story linked to a selected place, the story created by a writer;
receiving votes for the story from visitors to the place;
establishing a pricing model for newly created content and promotion of existing content that is based on votes received for the story;
providing a remuneration to the writer and a curator of the place in accord with the pricing model.

2. The method of claim 1, the step of establishing a pricing model further comprising allocating a bonus-per-vote and a rate-per-vote for selected activities.

3. The method of claim 1, further comprising establishing a community of like-minded people who visit the same places and vote for the same stories.

4. The method of claim 3, the step of establishing a pricing model further comprising factoring into the pricing model the number of like-minded people.

5. The method of claim 1, further comprising providing investment options for funding digital content creation, remuneration of writers and curators, and related marketing campaigns.

6. The method of claim 5, the step of providing investment options further comprising attracting capital from investors.

7. The method of claim 6, further comprising attracting capital from angel investors, curator-investors, and merchants.

8. The method of claim 1, further comprising:
initiating at least one marketing campaign to promote the competitive advantages of a place by promoting stories.

9. The method of claim 1, further comprising:
establishing a budget to fund remunerations; and
providing the remunerations to writers and curators until the budget is depleted or a marketing campaign with allocated budget is closed.

10. The method of claim 9, further comprising providing returns to investors from the allocated budget.

11. The method of claim 9, further comprising:
generating an offer to writers to provide remuneration for stories by the writers related to the place that are published in the online guide or subscribed to that guide; and
funding the offer to writers through the budget to fund remunerations.

12. The method of claim 11, wherein writers that are subscribed to the guide are notified of the offer to writers.

13. The method of claim 1, further comprising:
generating an offer to curators to provide compensation for managing the guide to the place and its content; and
funding the offer to curators through investment proceeds allocated to the place or earnings of the place.

14. The method of claim 13, wherein curators of other guides are notified of the offer to curators.

15. The method of claim 13, further comprising, after an offer to curators is generated, automatically generating an offer to writers to provide remuneration for stories which are written by the writers, published in a guide, and related to the place.

16. The method of claim 13, wherein the investment proceeds are received from any user in a standard procedure, further comprising allocating the investment proceeds to the remuneration of writers and to the compensation of curators.

17. The method of claim 13, wherein the investment proceeds are received from a merchant, the merchant having ownership rights in the place, further comprising allocating the investment proceeds to the remuneration of writers, to the compensation of curators, and to the returns of investors.

18. The method of claim 1, wherein the step of establishing a pricing model is further based on a likeness index which measures a similarity of profiles between independent visitors who vote for the story.

19. The method of claim 1, wherein the step of establishing a pricing model is further based on a highlight rate which measures a popularity of a specific highlight in the story.

20. The method of claim 1, further comprising:
receiving the story from the writer prior to publishing the story;
forwarding the story to a curator for approval or rejection, wherein the story is published in the guide if approved by the curator.

21. The method of claim 18, further comprising:
reevaluating the likeness index after a new vote is received or the number of like-minded people in the relevant community is updated.

22. The method of claim 1, further comprising:
assigning values to different places; and
attracting internal or external investment to fund stories and guides for the different places.

23. The method of claim 1, further comprising:
receiving an investment from a community guide system.

24. The method of claim 1, further comprising:
receiving an application from a user to become a curator of a guide for a place;
reviewing the application; and
if the application is approved, assigning the user a role of the curator.

25. The method of claim 1, further comprising:
identifying like-minded people in the system.

26. The method of claim 1, further comprising:
receiving a claim for ownership rights for the place.

27. The method of claim 7, wherein the capital is invested by an angel investor or a curator investor, further comprising allocating all of the capital toward remuneration of writers as a bonus per vote.

28. The method of claim 7, wherein the capital is invested by a merchant, further comprising:
allocating all of the capital toward remuneration of writers as a bonus per vote; and
allocating additional merchant funds to compensation of the curator and the system.

29. The method of claim 7, wherein the capital is invested by a merchant, further comprising:
allocating a first portion of the capital toward remuneration of writers as a royalty per vote; and
allocating a second portion of the capital toward compensation of the curator and the system.

30. A method for creating and promoting digital content, comprising:
establishing a pricing model for compensating writers of content and investors, the pricing model based on votes received for a published story;
receiving an investment from an investor;
allocating a budget from the investment for compensating writers of content and investors; and
providing compensation to writers and returns to investors for a published story from the allocated budget.

31. A system for creating and promoting digital content, comprising:
a server having at least one processor that executes program code including instructions to:
publish a story linked to a selected place, the story created by a writer;
receive votes for the story from visitors to the place;
establish a pricing model for newly created content and promotion of existing content that is based on votes received for the story; and
provide a remuneration to the writer and a curator of the place in accord with the pricing model.

32. The system of claim 31, comprising further instructions to:
generate an offer to writers to provide remuneration for stories by the writers related to the place that are published in the online guide; and
fund the offer to writers through the budget to fund remunerations.

33. The system of claim 31, comprising further instructions to:
generate an offer to curators to provide compensation for managing the guide to the place and its content; and
fund the offer to curators through investment proceeds allocated to the place or earnings of the place.
